(19) United States
(12) Patent Application Publication
(10) Pub. No.: US 2014/0079189 A1
(43) Pub. Date: Mar. 20, 2014

(54) X-RAY GENERATING DEVICE AND X-RAY-GENERATING-DEVICE CONTROL

(71) Applicants: Akihiro Miyamoto, Tokyo (JP); Yuichiro Kamino, Tokyo (JP); Shinya Ishii, Tokyo (JP); Tatsufumi Aoi, Tokyo (JP); Akira Watanabe, Tokyo (JP)

(72) Inventors: Akihiro Miyamoto, Tokyo (JP); Yuichiro Kamino, Tokyo (JP); Shinya Ishii, Tokyo (JP); Tatsufumi Aoi, Tokyo (JP); Akira Watanabe, Tokyo (JP)

(21) Appl. No.: 14/114,624

(22) PCT Filed: Jan. 24, 2012
(86) PCT No.: PCT/JP2012/051436

§ 371 Date: Oct. 29, 2013

(30) Foreign Application Priority Data
Jul. 22, 2011 (JP) 2011-160857

(51) Int. Cl. H01J 35/02

(52) U.S. Cl. CPC H01J 35/025
USPC 378/138

(57) ABSTRACT

An X-ray generating device (10) is provided with an electron gun (12) that generates an electron beam, a linear accelerator (14) that accelerates, by means of microwaves, the electron beam generated by the electron gun (12), an X-ray target (16) that generates X-rays by being irradiated with the electron beam accelerated by the linear accelerator (14), a microwave generating device that generates microwaves to be introduced into the linear accelerator (14), and a pulse modulator that controls the microwave generating device so as to change the power of the microwaves. Because the linear accelerator (14) includes a plurality of buncher cavities (40), even if there are electrons that are shifted out of the acceleration phase when the power of the microwaves is decreased, these electrons can be accelerated in the acceleration phase of the next time period; therefore, a decrease in the intensity of an electron beam to be emitted is suppressed even if the power of the microwaves is decreased.

### TECHNICAL FIELD

The present invention relates to an X-ray generating device and an X-ray-generating-device control method.

### BACKGROUND ART

In some cases, non-destructive inspection devices that are employed to perform, for example, luggage inspection at an airport or the like, and that utilize X-ray radiation (hereinafter, referred to as “X-rays”) include an X-ray tube driven by a tube voltage of about several tens to several hundreds of kilovolts. Such non-destructive inspection devices irradiate an object under inspection, such as luggage or the like, with X-rays output from the X-ray tube and form areas of high and low bulk density (product of specific gravity and the density of the material) of the object under inspection into an image based on the spatial distribution of the X-ray radiation level transmitted through the object under inspection.

In addition, in some cases, the non-destructive inspection devices described above identify the atomic number (perform elemental identification) of the object under inspection by taking advantage of the fact that individual elements differ in terms of the X-ray energy dependency of X-ray attenuation (linear absorption coefficient). For the purpose of such elemental identification, the non-destructive inspection devices described above radiate X-rays by changing the tube voltage of the X-ray tube, or radiate X-rays at different tube voltages by using a plurality of X-ray tubes, and thus, the atomic number of an object under inspection is identified by obtaining radiographs produced by, for example, two different tube voltages, that is to say, two different X-ray energies.

On the other hand, with non-destructive inspection utilizing X-rays performed at ports or borders on cargo having large bulk densities, such as containers or the like, X-rays generated by an X-ray tube driven by a tube voltage of several hundred kilovolts do not have sufficient transmitting capacity, and thus, non-destructive inspection is performed by using X-rays having greater energies.

In order to obtain high-energy X-rays, an accelerator known as a linear accelerator (Linear Accelerator: LINAC) is mainly employed, and, by irradiating a target material with electrons accelerated by the linear accelerator to achieve high energy (about 3 MeV to 9 MeV), high-energy X-rays are generated at the target material due to bremsstrahlung. In this way, because non-destructive inspection devices employing a linear accelerator can produce X-rays having greater energy than the X-rays generated by an X-ray tube, the X-rays therefrom can also pass through an object under inspection having relatively large bulk density such as a container or the like, making it possible to obtain a radiograph thereof.

Here, an X-ray generating device employing a linear accelerator will be described.

An X-ray generating device employing a linear accelerator is provided with an electron gun, a buncher, an accelerating tube, an X-ray target, a pulse modulator, and a microwave generating device, and an electron beam generated by the electron gun is accelerated by the buncher and the accelerating tube and is radiated onto the X-ray target.

More specifically, the pulse modulator generates high-voltage pulses, and the generated high-voltage pulses are applied to the electron gun and the microwave generating device.

Upon receiving the high-voltage pulses applied by the pulse modulator, the electron gun generates an electron beam, and the generated electron beam enters the buncher. Note that the electron density of the electron beam that enters the buncher is temporally uniform across the high-voltage pulse width.

On the other hand, upon receiving the high-voltage pulses applied by the pulse modulator, the microwave generating device generates high-power microwaves of several megawatts (MW). Note that the pulse width of the high-voltage pulses is sufficiently greater than the period of the microwaves generated by the microwave generating device.

Then, the microwaves generated by the microwave generating device enter the accelerating tube, which is formed of a plurality of resonant cavities that are joined together. Note that the resonant cavities forming the accelerating tube are referred to as accelerating cavities. The microwaves that have entered the accelerating tube are made to resonate by the respective accelerating cavities, thus exciting, in the respective accelerating cavities, accelerating electric fields. The accelerating electric fields accelerate the electron beam that vibrate at the frequency of the microwaves, and that are directed in the central axis direction. Note that the phase difference between accelerating electric fields excited in the adjacent accelerating cavities is assumed to be 180°.

In addition, the buncher is also formed of a resonant cavity, and the microwaves that have entered the accelerating tube are transmitted through the interior of the accelerating tube and also excite an accelerating electric field in the buncher. Then, the electron beam that has entered the buncher from the electron gun is subjected to velocity modulation by the accelerating electric field excited in the buncher. In other words, an electron beam entering the buncher at the timing when the accelerating electric field in the buncher becomes positive is accelerated, whereas an electron beam entering the buncher at the timing when the accelerating electric field becomes negative is decelerated.

Because of this, the electron density of the electron beam that is temporally uniform across the high-voltage pulse width at the time of entering the buncher is affected by the above-described velocity modulation, thereby gradually being bunched (subjected to bunching), and thus, variability appears in accordance with a time period determined by the frequency of the microwaves.

The shape of the resonant cavity in the buncher is designed so as to synchronize the timing at which a portion of the bunched electron beam having a high electron density enters the accelerating tube with the timing at which the accelerating electric field in the first accelerating cavity of the accelerating tube becomes positive, and, by synchronizing them in this way, it is possible to efficiently accelerate the electrons by the positive accelerating electric field, and it is also possible to reduce the number of electrons that are accelerated by a negative accelerating electric field in the reverse direction back toward the electron gun.

Note that, although the phase difference is assumed to be 180° among the accelerating electric fields of the accelerating cavities that are adjacent to each other in the accelerating tube, the shape of the accelerating cavities is designed so as to synchronize the timing at which electrons accelerated by the first accelerating cavity of the accelerating tube reach the adjacent accelerating cavity with the timing at which the accelerating electric field of the adjacent accelerating cavity becomes positive, and the electrons are accelerated even more by achieving the synchronization in this way. The linear accelerator also accelerates the electrons in a similar manner at the plurality of accelerating cavities in synchronization with the timing at which the accelerating electric fields thereof become positive, thereby generating an electron beam having the desired high energy.

Then, the accelerated high-energy electron beam is radiated onto the X-ray target, and thus, high-energy bremsstrahlung X-rays are obtained.

Furthermore, when performing elemental identification by using a non-destructive inspection device employing a linear accelerator, it is necessary to employ a linear accelerator possessing two different levels of electron-beam energy, as with the case of an X-ray tube.

For example, in the case of an X-ray tube employed in a non-destructive inspection device for performing luggage inspection, X-rays having different energy levels can easily be achieved by changing the tube voltage of the X-ray tube. In addition, because X-ray tubes are relatively inexpensive, it is economically viable to install two X-ray tubes in a non-destructive inspection device.

However, linear accelerators are more expensive than X-ray tubes, and it results in a large increase in cost if two different linear accelerators are installed in a non-destructive inspection device in order to achieve two different levels of electrons energy.

Here, according to the description in Patent Literature 1, a relational expression indicated by the following Expression (1) holds, assuming that the power of microwaves entering the accelerating tube (hereinafter, referred to as “microwave power”) is P, the current value of an electron beam is I, and the energy of the electron beam is E. Note that A and B are constant.

{Eq. 1}

E=\sqrt{A×P}−B×I (1)

Therefore, if the power of microwaves to be introduced into the accelerating tube is decreased and the current of the electron beam is increased, the energy of the electron beam will decrease.

The linear accelerator utilizes the relationship indicated by Expression (1) to decrease the microwave power output from a microwave amplifier by decreasing the maximum voltage value of the high-voltage pulses relative to the rated value, and to increase the current value of the electron beam that the electron gun generates by increasing the grid voltage of the electron gun relative to the rated value, thus making it possible to output an electron beam having a lower accelerating energy than the rated value. Then, the linear accelerator switches such control for each pulse of the high-voltage pulses from the pulse modulator, thus making it possible to generate electron beams having two different levels of accelerating energy.

### CITATION LIST

### Patent Literature

{PTL 1} U.S. Pat. No. 7,646,851, Specification

### SUMMARY OF INVENTION

### Technical Problem

However, decreasing the power of microwaves to be introduced into the accelerating tube by means of the control method disclosed in Patent Literature 1 causes the following problems.

When the power of microwaves that enter the accelerating tube is decreased below the rated value, the accelerating electric fields excited at the accelerating cavities are decreased. Because this causes a reduction in the velocity of the electrons to be accelerated as compared with that during the rated operation when operated with the rated microwave power, a longer time is required to pass through a single accelerating cavity as compared with during the rated operation.

Because of this, the timing at which the electrons reach the next accelerating cavity is delayed as compared with during the rated operation. Due to this timing delay, at the point in time when the electrons reach the next resonant driving, the phase of the accelerating electric field of the next accelerating cavity is about to change from positive to negative. In other words, the electrons are not accelerated by an appropriate positive accelerating electric field when the timing at which they reach the next accelerating cavity is delayed, thus decreasing the current of an electron beam that reaches the X-ray target by being appropriately accelerated in the accelerating tube.

The problem, such as the one described above, that electrons cannot reach the accelerating electric fields in time to be matched with the positive phase thereof is particularly problematic at the first accelerating cavity of an accelerating tube into which electrons enter. The reason for this is as described below.

In general, a relationship indicated by the following Expression (2) holds between the velocity v of high-energy electrons and the accelerating energy E.

$$\begin{matrix}\{ Eq . 2 \} & \\ β = \sqrt{1 - \frac{1}{{( 1 + \frac{E}{{E}_{0}} )}^{2}}} \\ β = \frac{v}{c} & ( 2 )\end{matrix}$$

### c: SPEED OF LIGHT

### E₀: REST ENERGY OF ELECTRON(0.511 MeV)

According to Expression (2), when electrons are accelerated to 1 MeV from the resting state, the velocity of the electrons reaches 94% of the speed of light. Then, once the energy exceeds about 1 MeV, the electrons approach the speed of light, which is the upper limit of the velocity, with an increasing acceleration. Therefore, the major part of the change (increase) in the electron velocity occurs before the electrons are accelerated to about 1 MeV, and the velocity changes moderately once about 1 MeV is exceeded.

Because of this, the problem that the electrons cannot reach the accelerating electric fields in time to be matched with the positive phase thereof when the microwave power is decreased is prominent at the first accelerating cavity of the accelerating tube which the electrons enter. Then, due to this problem, the current value of an electron beam that is accelerated in the accelerating tube and radiated onto the X-ray target is decreased, and, as a result, the radiation level of the generated X-rays is also decreased.

In addition, the radiation level of the X-rays generated due to bremsstrahlung when an electron beam is radiated onto an X-ray target generally decreases with a decrease in the energy of an electron beam. Because of this, the X-ray radiation level that is transmitted through an object under inspection also decreases with a decrease in the energy of the electron beam; and, in the case in which low-energy X-rays are generated, it is not possible to obtain a high enough S/N ratio for obtaining a satisfactory image, and, in addition, it is necessary to ensure a wide enough sensitivity range of an X-ray detector.

The present invention has been conceived in light of the above-described circumstances, and an object thereof is to provide an X-ray generating device and an X-ray-generating-device control method with which fluctuations in the radiation level of the generated X-rays can be suppressed even if electron beams having different energy levels are emitted from a linear accelerator.

### Solution to Problem

In order to solve the above-described problems, an X-ray generating device and an X-ray-generating-device control method of the present invention employ the following solutions.

An X-ray generating device according to a first aspect of the present invention includes an electron-beam generating unit for generating an electron beam; a linear accelerator that includes a plurality of buncher cavities and a plurality of accelerating cavities and that accelerates, by means of microwaves, the electron beam generated by the electron-beam generating unit; a target that generates X-rays by being irradiated with the electron beam accelerated by the linear accelerator; a microwave generating unit for generating microwaves to be introduced into the linear accelerator; and a controlling unit for controlling the microwave generating unit so as to change the power of the microwaves.

With the above-described configuration, an electron beam is generated by the electron-beam generating unit, the electron beam generated by the electron-beam generating unit is accelerated by the linear accelerator having the plurality of buncher cavities and the plurality of accelerating cavities by means of the microwaves, and X-rays are generated by radiating the electron beam accelerated by the linear accelerator onto the target. Non-destructive inspection is performed by irradiating an object under inspection with the X-rays generated in this way.

In addition, the microwave generating unit is controlled by the controlling unit so as to change the power of the microwaves to be introduced into the linear accelerator. Because the energy of the electron beam accelerated by the linear accelerator is changed by changing the power of the microwaves, it is also possible to change the energy of the X-rays generated at the target, and thus, it is possible to perform elemental identification on an object under inspection by using X-rays having different energy levels.

Here, because the velocity of the electron beam is decreased if the power of the microwaves is decreased below that during the rated operation, the timing at which electrons reach an accelerating cavity is delayed as compared with the rated operation, which causes the electrons to shift out of the acceleration phase, preventing the electrons from being accelerated in an appropriate positive accelerating electric field. Because of this, the intensity of the electron beam emitted from the linear accelerator is considerably decreased as compared with the case in which the electrons are accelerated in the rated operation.

However, in the case in which the linear accelerator includes a plurality of the buncher cavities, the electron beam is accelerated in the acceleration phase of the next time period even if the electron beam shifts out of the acceleration phase. Then, because the electron beam that has passed through the plurality of buncher cavities is accelerated close to the speed of light, the electron beam can pass through the accelerating cavities located on the downstream side of the buncher cavities, requiring nearly the same amount of time as with the case of the rated operation.

As described above, with the present invention, because the linear accelerator includes the plurality of buncher cavities, even if there are electrons that are shifted out of the acceleration phase when the power of the microwaves is decreased, these electrons can be accelerated in the acceleration phase of the next time period. Therefore, because a decrease in the intensity of the electron beam to be emitted is suppressed even if the power of the microwaves is decreased, it is possible to suppress fluctuations in the radiation level of the generated X-rays even if the energy of the electron beam emitted from the linear accelerator is made to differ.

In addition, in the first aspect described above, it is preferable that the controlling unit change a frequency at which the microwaves are repeatedly introduced in a pulsed manner in accordance with the magnitude of the power of the microwaves to be introduced into the linear accelerator from the microwave generating unit.

When the intensity of an electron beam emitted from a linear accelerator changes in accordance with the energy of the electron beam, making the radiation level of the low-energy X-rays lower than the radiation level of the high-energy X-rays, it becomes necessary to employ an X-ray detector having a wide sensitivity range.

Therefore, with the above-described configuration, because the frequency at which the microwaves are repeatedly introduced in a pulsed manner can be changed in accordance with the power of the microwaves to be introduced into the linear accelerator, it is possible to increase or decrease the amount of electron beam current in accordance with the power of the microwaves. Therefore, because an object under inspection can be irradiated with X-rays having an equivalent radiation level between the case in which the high-energy X-rays are generated and the case in which the low-energy X-rays are generated, it is not necessary to ensure a wide enough sensitivity range of the X-ray detector.

In addition, in the first aspect described above, it is preferable that the controlling unit generate high-energy X-rays by introducing the microwaves having a power corresponding to that during the rated operation into the linear accelerator from the microwave generating unit, and generates low-energy X-rays by introducing the microwaves having a power lower than the power of microwaves during the rated operation into the linear accelerator from the microwave generating unit.

With the above-described configuration, because the high-energy X-rays and the low-energy X-rays are generated by using the microwaves having a power corresponding to that during the rated operation as a reference, it is possible to easily generate X-rays having different energy levels.

An X-ray generating device according to a second aspect of the present invention includes an electron-beam generating unit for generating an electron beam; a linear accelerator that accelerates, by means of microwaves, the electron beam generated by the electron-beam generating unit; a target that generates X-rays by being irradiated with the electron beam accelerated by the linear accelerator; a microwave generating unit for generating microwaves to be introduced into the linear accelerator; and a controlling unit for controlling the microwave generating unit so as to change the power of the microwaves, wherein the controlling unit changes a frequency at which the microwaves are repeatedly introduced in a pulsed manner in accordance with the magnitude of the power of the microwaves to be introduced into the linear accelerator from the microwave generating unit.

An X-ray-generating-device control method according to a third aspect of the present invention is a control method of an X-ray generating device provided with an electron-beam generating unit for generating an electron beam; a linear accelerator that includes a plurality of buncher cavities and a plurality of accelerating cavities and that accelerates, by means of microwaves, the electron beam generated by the electron-beam generating unit; a target that generates X-rays by being irradiated with the electron beam accelerated by the linear accelerator; a microwave generating unit for generating microwaves to be introduced into the linear accelerator; and a controlling unit for controlling the microwave generating unit so as to change the power of the microwaves, the control method including introducing microwaves having a power of a first magnitude into the linear accelerator from the microwave generating unit, of accelerating the electron beam generated by the electron-beam generating unit, and of generating X-rays by radiating the electron beam onto the target; and introducing microwaves having a power of a different magnitude from the microwave power of the first magnitude into the linear accelerator from the microwave generating unit, of accelerating the electron beam generated by the electron-beam generating unit, and of generating X-rays by radiating the electron beam onto the target.

### Advantageous Effects of Invention

The present invention affords an excellent advantage in that fluctuations in the radiation level of the generated X-rays can be suppressed even if electron beams having different energy levels are emitted from a linear accelerator.

### BRIEF DESCRIPTION OF DRAWINGS

FIG. 1 is a diagram showing the configuration of an X-ray generating device according to a first embodiment of the present invention.

FIG. 2 is a cross-sectional view of a linear accelerator according to the first embodiment of the present invention.

FIG. 3 is a graph showing an accelerating-electric-field distribution of the linear accelerator according to the first embodiment of the present invention.

FIG. 4 is a schematic diagram showing acceleration of an electron group by the linear accelerator according to the first embodiment of the present invention.

FIG. 5 is a graph showing an energy-spectrum distribution of X-rays generated by the X-ray generating device according to the first embodiment of the present invention.

FIG. 6 shows a time distribution of the radiation level of X-rays generated by an X-ray generating device according to a second embodiment of the present invention.

### DESCRIPTION OF EMBODIMENTS

Embodiments of an X-ray generating device and an X-ray-generating-device control method according to the present invention will be described below with reference to the drawings.

### First Embodiment

A first embodiment of the present invention will be described below.

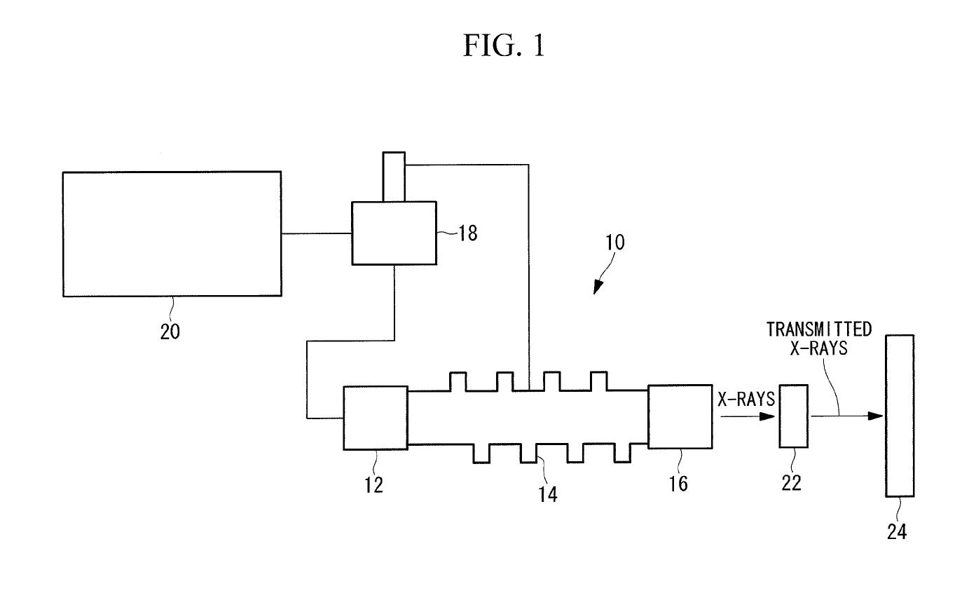

FIG. 1 is a diagram showing the configuration of an X-ray generating device 10 according to the first embodiment.

As shown in FIG. 1, the X-ray generating device 10 is provided with an electron gun 12, a linear accelerator 14, an X-ray target 16, a microwave generating device 18, and a pulse modulator 20.

The electron gun 12 generates an electron beam, and the generated electron beam is accelerated by the linear accelerator 14 and is radiated onto the X-ray target 16. Then, the X-ray target 16 generates X-rays due to bremsstrahlung, in accordance with the energy of the electron beam, and an object 22 under inspection is irradiated with these X-rays. Then, the X-rays transmitted through the object 22 under inspection are detected by an X-ray detector 24, and an X-ray radiograph is obtained.

In addition, the pulse modulator 20 generates high-voltage pulses, and the generated high-voltage pulses are applied to the electron gun 12 and the microwave generating device 18. The pulse modulator 20 changes the power of microwaves generated at the microwave generating device 18 by changing the magnitude of the high-voltage pulses.

Upon receiving the high-voltage pulses applied by the pulse modulator 20, the electron gun 12 generates an electron beam and makes it enter the linear accelerator 14. On the other hand, upon receiving the high-voltage pulses applied by the pulse modulator 20, the microwave generating device 18 generates high-power (several megawatts (MW)) microwaves in accordance with the high-voltage pulses and introduces them into the linear accelerator 14.

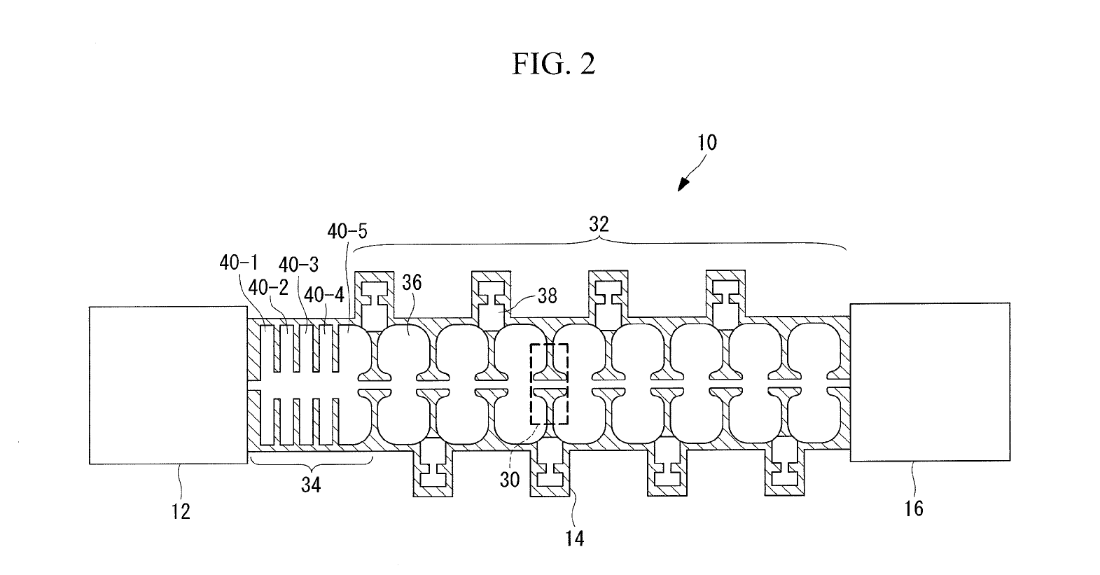

FIG. 2 is a cross-sectional view of the linear accelerator 14 according to the first embodiment.

The linear accelerator 14 is provided with a microwave introduction window 30, an accelerating tube 32, and a buncher portion 34. The accelerating tube 32 is formed of a plurality of accelerating cavities 36, the plurality of which are joined together, and also includes a plurality of side-coupled cavities 38. The buncher portion 34 includes a plurality of buncher cavities 40-1 to 40-5. Note that, in the following description, one of 1 to 5 will be added to the end of the reference sign when the respective buncher cavities 40 are to be distinguished, and 1 to 5 will be omitted when the respective buncher cavities 40 are not to be distinguished.

The electron beam is accelerated by the buncher portion 34 to about 1 MeV, that is, close to the speed of light, and is accelerated even more by the accelerating tube 32.

The microwaves generated by the microwave generating device 18 are introduced into the accelerating tube 32 via the microwave introduction window 30. The microwaves introduced via the microwave introduction window 30 pass through the accelerating cavities 36 and the side-coupled cavities 38, thus exciting accelerating electric fields in all accelerating cavities 36.

Then, the microwaves transmitted to the accelerating cavity 36 on the upstream side closest to the electron gun 12 excite an accelerating electric field in the buncher cavity 40-5 via the side-coupled cavities 38.

The microwaves transmitted to the buncher cavity 40-5 are then transmitted to the buncher cavity 40-4, the buncher cavity 40-3, the buncher cavity 40-2, and the buncher cavity 40-1 in this order via beam holes, thus exciting accelerating electric fields in the respective buncher cavities 40.

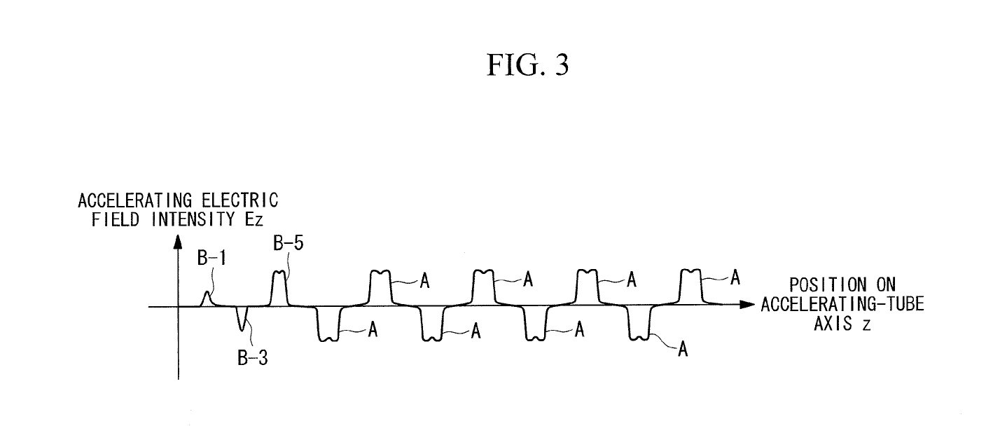

FIG. 3 is a graph showing an example distribution of the accelerating electric fields in the linear accelerator 14 according to the first embodiment, where the horizontal axis indicates the position (z) on the center axis of the accelerating tube 32, and the vertical axis indicates the intensity (Ez) of the accelerating electric fields. Accelerating electric fields A in FIG. 3 indicate respective accelerating electric fields excited in the accelerating cavities 36; an accelerating electric field B-5 indicates the accelerating electric field excited in the buncher cavity 40-5; an accelerating electric field B-3 indicates the accelerating electric field excited in the buncher cavity 40-3; and an accelerating electric field B-1 indicates the accelerating electric field excited in the buncher cavity 40-1. Note that the accelerating electric fields vibrate over time in accordance with the frequency of the microwaves.

As shown in FIG. 3, the phases of the accelerating electric fields A excited in the accelerating cavities 36 differ by 180° from those of adjacent accelerating cavities 36.

In addition, because the buncher cavities 40 according to the first embodiment excite standing waves in the n/2 (half n) mode, accelerating electric fields are excited in the buncher cavities 40-1, 40-3, and 40-5, whereas accelerating electric fields are not excited in the buncher cavities 40-2 and 40-4.

Then, in the linear accelerator 14, the electron beam generated by the electron gun 12 is made to enter the buncher cavity 40-1 of the buncher portion 34 in the state in which the accelerating electric fields are excited in the buncher portion 34 and the accelerating tube 32.

The electron beam that has entered the buncher cavity 40-1 is bunched by the accelerating electric fields and is also accelerated close to the speed of light, while passing through from the buncher cavity 40-2 to the buncher cavity 40-5, and the electron beam is made to enter the accelerating cavities 36. The electron beam that has entered the accelerating cavities 36 is synchronized with the acceleration phase of the accelerating electric fields of the accelerating cavities 36, thus being accelerated to an even higher energy level.

Then, the electron beam emitted from the accelerating cavities 36 is radiated onto the X-ray target 16, and thus, X-rays are generated in the X-ray target 16.

Next, effects of providing the plurality of buncher cavities 40 in the linear accelerator 14 will be described.

Because the buncher portion 34 is formed of the plurality of buncher cavities 40, the linear accelerator 14 can obtain an electron beam having lower energy than during the rated operation merely by decreasing the power of microwaves to be introduced, without greatly decreasing the intensity of the electron beam. The reason for this is as described below.

As described above, the electron beam made to enter the buncher portion 34 from the electron gun 12 is made to enter the accelerating cavities 36 after the electron beam is bunched and is also accelerated close to the speed of light by the accelerating electric fields B-1, B-3, and B-5 excited in the buncher cavities 40.

Here, with the buncher portion 34 of the accelerating tube 32 according to the first embodiment, because the energy of the electrons accelerated at the buncher portion 34 is decreased when the power of microwaves introduced into the accelerating tube 32 is decreased, the electron velocity is decreased, thus making some electrons unable to reach the accelerating electric field B-3 and the accelerating electric field B-5 in time to be matched with the acceleration phases thereof.

For example, electrons that failed to reach the accelerating electric field B-3 (n) (n is the periodicity of microwaves to be introduced) in time may accumulate near the buncher cavity 40-3 or may travel in the reverse direction back toward the buncher cavity 40-1.

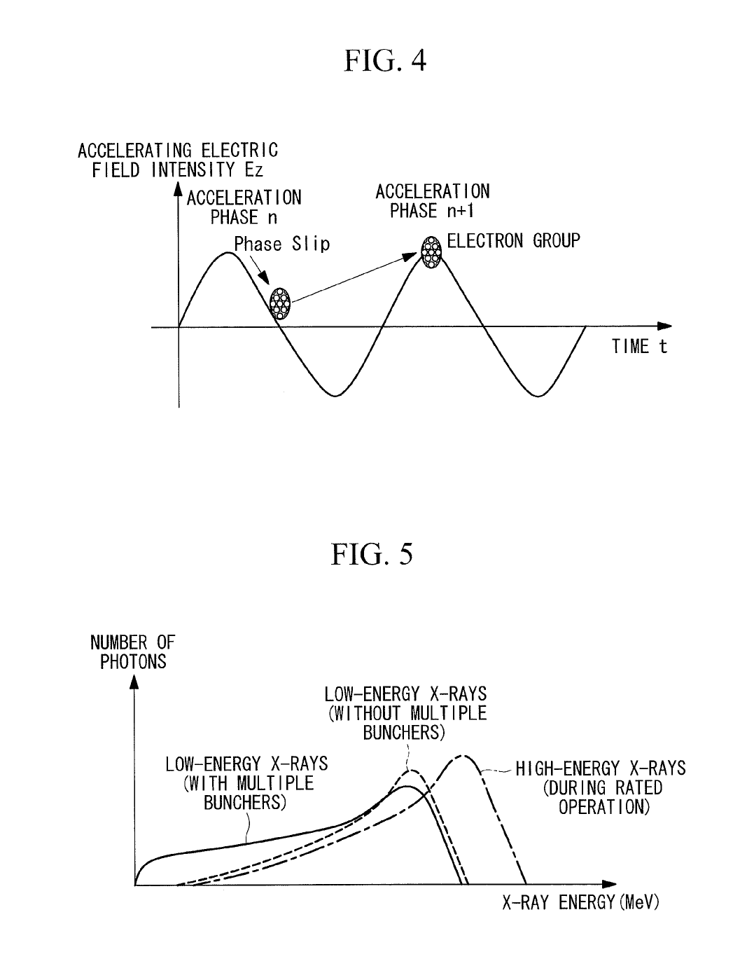

However, as shown in FIG. 4, electrons accumulating near the buncher cavity 40-3 are reaccelerated (recaptured) in an acceleration phase (n+1) in the next time period of the accelerating electric field B-3, and thus, the electrons can join an electron group that has been bunched at the speed of light. In addition, electrons traveling in the reverse direction back toward the buncher cavity 40-1 are also reaccelerated (recaptured) in the acceleration phase of the accelerating electric field B-1 excited in the buncher cavity 40-1, and thus, the electrons can join the electron group that has been bunched at the speed of light.

Note that this is the same for electrons that fail to reach the accelerating electric field B-5 in time for the acceleration phase thereof.

As described above, by forming the buncher portion 34 with the plurality of buncher cavities 40, electrons can be efficiently bunched and accelerated close to the speed of light, and the electrons can be made to enter the accelerating cavities 36 even if the power of microwaves to be introduced into the linear accelerator 14 is decreased below the rated value (microwave power obtained during the rated operation).

Furthermore, because the electron beam (electron group) made to enter the accelerating cavities 36 is already accelerated close to the speed of light due to the acceleration at the buncher portion 34, even if the microwave power is decreased below the rated value, the electrons can pass through the accelerating cavities 36 located on the downstream side of the buncher cavities, requiring substantially the same amount of time as with the case of the rated operation. Because of this, the linear accelerator 14 can accelerate the electron beam without greatly shifting out of the acceleration phases of the accelerating electric fields, even if the power of microwaves to be introduced is decreased.

As described above, with the linear accelerator 14 according to the first embodiment, because the electron beam can be matched with the acceleration phase again even if the electron beam entering from the electron gun 12 is shifted out of the acceleration phase of the buncher portion 34, it is possible to emit electron beams having different energy levels by using a single accelerating tube 32 merely by changing the microwave power, which is an operating condition, without decreasing the intensity of the electron beam (electron beam current) emitted from the linear accelerator 14.

In addition, with the X-ray generating device 10 according to the first embodiment, because it is not necessary to optimize the energy of the electron beam generated by the electron gun 12 in accordance with the energy of the electron beam emitted from the linear accelerator 14, it is possible to change the energy of the electron beam by means of simple control.

As described above, with the X-ray generating device 10 according to the first embodiment, because it is possible to avoid a decrease in the electron beam current even if the energy of the electron beam emitted from the linear accelerator 14 is changed, it is possible to obtain X-rays having a sufficient radiation level, and thus, it is not necessary to increase the sensitivity range of the X-ray detector.

Furthermore, as described above, because electrons shifted out of the acceleration phase are recaptured by the plurality of buncher cavities 40 when the power of microwaves to be introduced is decreased as compared with that during the rated operation, the spread of the electron group in the accelerating axis direction (phase spread) is increased as compared with that during the rated operation.

Because of this, the energy spectrum of an electron beam accelerated by using lower microwave power than that during the rated operation is wider than the energy spectrum during the rated operation and includes a large amount of components on the low energy side, thus making the electron beam have effective energy that is effectively even lower than the microwave power raised to the ½ power (one half power).

Thus, as shown in FIG. 5, an energy spectrum of X-rays generated by an electron beam accelerated by using lower microwave power than that during the rated operation (low-energy X-rays with multiple bunchers) has lower energy than high-energy X-rays generated in the rated operation.

Furthermore, the effective energy of the X-rays also becomes lower (less sharp) as compared with the energy spectrum of conventional low-energy X-rays (without multiple bunchers). Because of this, the effective difference between the two energy levels of the high-energy X-rays and the low-energy X-rays obtained by the X-ray generating device 10 according to this embodiment becomes larger as compared with a conventional case. Note that, an X-ray generating device that generates the conventional low-energy X-rays referred to here is, for example, a device that generates low-energy X-rays by decreasing the power of microwaves to be introduced into a linear accelerator having a single buncher cavity so as to be below that during the rated operation.

As a result, with the X-ray generating device 10 according to the first embodiment, it is possible to obtain an X-ray transmission image having a greater contrast, which is useful when performing elemental identification for identifying the atomic number of the object 22 under inspection. Therefore, it is possible to achieve the required performance as a non-destructive inspection device, as well as sufficient cost reduction, when employing the X-ray generating device 10 in a non-destructive inspection device for a container or the like to perform inspection based on elemental identification.

Note that the X-ray generating device 10 according to the first embodiment executes non-destructive inspection in which the object 22 under inspection is, for example, cargo having a large bulk density, such as a container or the like, by means of a method like the one described below.

The X-ray generating device 10 introduces microwaves having a power corresponding to that during the rated operation into the linear accelerator 14 from the microwave generating device 18, accelerates an electron beam generated by the electron gun 12, and generates high-energy X-rays by irradiating the X-ray target 16 with the electron beam. The object 22 under inspection is irradiated with the generated high-energy X-rays, and the X-ray detector 24 detects the X-rays transmitted through the object 22 under inspection, thus processing them as a transmission image.

Subsequently, the X-ray generating device 10 introduces microwaves whose power magnitude is lower than the magnitude of the power of microwaves during the rated operation into the linear accelerator 14 from the microwave generating device 18, accelerates the electron beam generated by the electron gun 12, and generates X-rays by irradiating the X-ray target 16 with the electron beam. The above-described object 22 under inspection is irradiated with the generated low-energy X-rays, and the X-ray detector 24 detects the X-rays transmitted through the object 22 under inspection, thus processing them as a transmission image.

Then, elemental identification is performed on the object 22 under inspection based on transmission images of the two types of different X-rays detected by the X-ray detector 24.

As described above, the X-ray generating device 10 according to the first embodiment is provided with the electron gun 12 that generates an electron beam, the linear accelerator 14 that accelerates, by means of microwaves, the electron beam generated by the electron gun 12, the X-ray target 16 that generates X-rays when irradiated with the electron beam accelerated by the linear accelerator 14, the microwave generating device 18 that generates the microwaves to be introduced into the linear accelerator 14, and the pulse modulator 20 that controls the microwave generating device 18 so as to change the power of the microwaves.

Then, because the linear accelerator 14 includes the plurality of buncher cavities 40, even if there are electrons that are shifted out of the acceleration phase when the power of the microwaves is decreased, these electrons can be accelerated in the acceleration phase of the next time period. Therefore, because a decrease in the intensity of the emitted electron beam is suppressed even if the power of the microwaves is decreased, it is possible to suppress fluctuations in the radiation level of the generated X-rays even if the energy of the electron beam emitted from the linear accelerator 14 is made to differ.

In addition, with the X-ray generating device 10 according to the first embodiment, when generating X-rays having different energy levels, the microwaves having a power corresponding to that during the rated operation are introduced into the linear accelerator 14 from the microwave generating device 18, thereby generating high-energy X-rays, and microwave power lower than the microwave power during the rated operation is introduced into the linear accelerator 14 from the microwave generating device 18, thereby generating low-energy X-rays.

In other words, because the X-ray generating device 10 according to the first embodiment generates high-energy X-rays and low-energy X-rays by using the microwave power in the rated operation as a reference, X-rays having different energy levels can easily be generated.

### Second Embodiment

A second embodiment of the present invention will be described below.

The configuration of an X-ray generating device 10 according to the second embodiment is similar to the configuration of the X-ray generating device 10 according to the first embodiment shown in FIG. 1. However, a linear accelerator 14 according to the second embodiment need not include the plurality of buncher cavities 40.

Then, with the pulse modulator 20 according to the second embodiment, it is possible to change the frequency (periodicity) at which the microwaves are repeatedly introduced in a pulsed manner in accordance with the magnitude of the power of the microwaves to be introduced into the linear accelerator 14, by controlling the high-voltage pulses output to the microwave generating device 18.

With the X-ray generating device 10 that obtains X-rays having different energy levels by decreasing the microwave power output to the linear accelerator 14 from the rated value, the X-ray radiation level changes in accordance with the energy of the electron beam emitted from the linear accelerator 14, and thus, the radiation level of low-energy X-rays sometimes becomes lower than the radiation level of high-energy X-rays.

In such a case, the radiation levels of X-rays entering the X-ray detector 24 differs between the high-energy case and the low-energy case, which makes it necessary to increase the X-ray detection sensitivity range of the X-ray detector 24.

Therefore, with the X-ray generating device 10 according to the second embodiment, because it is possible to change the frequency at which the microwaves are repeatedly introduced in a pulsed manner in accordance with the magnitude of the power of microwaves to be introduced into the linear accelerator 14, it is possible to increase or decrease the amount of electron beam current in accordance with the magnitude of the microwave power. Therefore, the X-ray generating device 10 can irradiate the object 22 under inspection with X-rays having an equivalent radiation level between the case in which high-energy X-rays are generated and the case in which low-energy X-rays are generated.

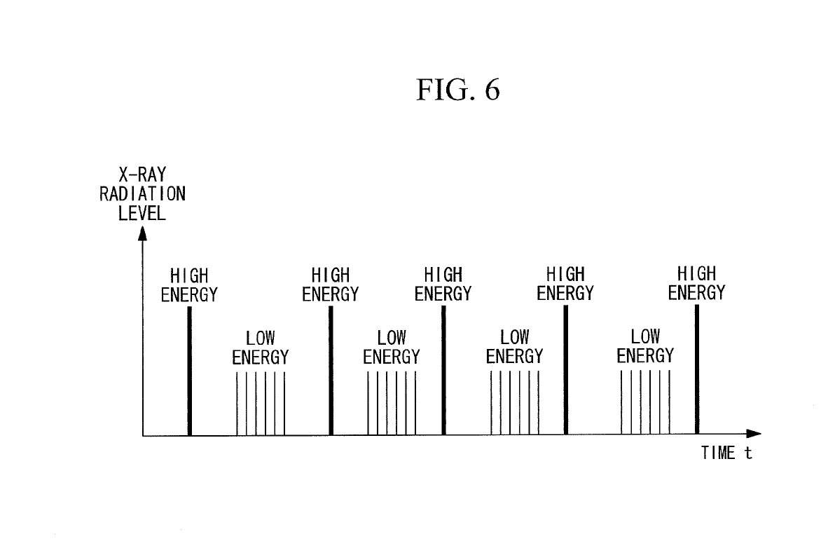

For example, when the radiation level of low-energy X-rays is ⅙ (one sixth) of the radiation level high-energy X-rays, by setting the pulses of the lower microwave power to 120 Hz and the pulses of the higher microwave power to 20 Hz and by introducing them into the linear accelerator 14, it is possible to achieve a time distribution of the X-ray radiation level like the one shown in FIG. 6, and it is possible to make the X-ray radiation level about the same between the low-energy X-rays and the high-energy X-rays.

Therefore, with the X-ray generating device 10 according to the second embodiment, it is not necessary to ensure a wide enough sensitivity range of the X-ray detector 24, and thus, it is possible to form a high-precision X-ray detection system.

As described above, although the present invention has been described by using the individual embodiments described above, the technical scope of the present invention is not limited to the scope described in the embodiments described above. Various alterations or improvements can be incorporated into the individual embodiments described above within a range that does not depart from the scope of the invention, and forms in which such alterations or improvements are incorporated are also encompassed within the technical scope of the present invention.

For example, in the individual embodiments described above, although a form in which standing waves in the π/2 mode are excited in the accelerating tube 32 and the buncher cavities 40 has been described, the present invention is not limited thereto, and a form in which, with the buncher cavities 40, accelerating electric fields are excited in all buncher cavities 40 in a n mode may be employed, or a form in which accelerating electric fields are excited in the buncher cavities 40 in other modes may be employed.

In addition, in the individual embodiments described above, although a form in which the electron beams emitted from the linear accelerator 14 have two energies has been described, the present invention is not limited thereto, and a form in which the electron beams emitted from the linear accelerator 14 have three or more energies may be employed.

### REFERENCE SIGNS LIST

10 X-ray generating device
12 electron gun
14 linear accelerator
16 X-ray target
18 microwave generating device
20 pulse modulator
36 accelerating cavity
40 buncher cavity

1. An X-ray generating device comprising:
an electron-beam generating unit for generating an electron beam;
a linear accelerator that includes a plurality of buncher cavities and a plurality of accelerating cavities and that accelerates, by means of microwaves, the electron beam generated by the electron-beam generating unit;
a target that generates X-rays by being irradiated with the electron beam accelerated by the linear accelerator;
a microwave generating unit for generating microwaves to be introduced into the linear accelerator; and
a controlling unit for controlling the microwave generating unit so as to change the power of the microwaves.

2. The X-ray generating device according to claim 1, wherein the controlling unit changes a frequency at which the microwaves are repeatedly introduced in a pulsed manner in accordance with the magnitude of the power of the microwaves to be introduced into the linear accelerator from the microwave generating unit.

3. The X-ray generating device according to claim 1, wherein the controlling unit generates high-energy X-rays by introducing the microwaves having a power corresponding to that during the rated operation into the linear accelerator from the microwave generating unit, and generates low-energy X-rays by introducing the microwaves having a power lower than the power of microwaves during the rated operation into the linear accelerator from the microwave generating unit.

4. An X-ray generating device comprising:
an electron-beam generating unit for generating an electron beam;
a linear accelerator that accelerates, by means of microwaves, the electron beam generated by the electron-beam generating unit;
a target that generates X-rays by being irradiated with the electron beam accelerated by the linear accelerator;
a microwave generating unit for generating microwaves to be introduced into the linear accelerator; and
a controlling unit for controlling the microwave generating unit so as to change the power of the microwaves,
wherein the controlling unit changes a frequency at which the microwaves are repeatedly introduced in a pulsed manner in accordance with the magnitude of the power of the microwaves to be introduced into the linear accelerator from the microwave generating unit.

5. A control method of an X-ray generating device provided with an electron-beam generating unit for generating an electron beam; a linear accelerator that includes a plurality of buncher cavities and a plurality of accelerating cavities and that accelerates, by means of microwaves, the electron beam generated by the electron-beam generating unit; a target that generates X-rays by being irradiated with the electron beam accelerated by the linear accelerator; a microwave generating unit for generating microwaves to be introduced into the linear accelerator; and a controlling unit for controlling the microwave generating unit so as to change the power of the microwaves, the control method comprising:
introducing microwaves having a power of a first magnitude into the linear accelerator from the microwave generating unit, of accelerating the electron beam generated by the electron-beam generating unit, and of generating X-rays by radiating the electron beam onto the target; and
introducing microwaves having a power of a different magnitude from the microwave power of the first magnitude into the linear accelerator from the microwave generating unit, of accelerating the electron beam generated by the electron-beam generating unit, and of generating X-rays by radiating the electron beam onto the target.
